(19) United States
(12) Patent Application Publication
(10) Pub. No.: US 2016/0297648 A1
(43) Pub. Date: Oct. 13, 2016

(54) STATOR REDUCTION IN ROPELESS ELEVATOR TRANSFER STATION

(71) Applicant: OTIS ELEVATOR COMPANY, Farmington, CT (US)

(72) Inventors: Tadeusz Witczak, Lodz (PL); Zbigniew Piech, Cheshire, CT (US)

(21) Appl. No.: 15/100,856

(22) PCT Filed: Dec. 5, 2013
(86) PCT No.: PCT/US2013/073322

§ 371 Date: Jun. 1, 2016

(51) Int. Cl. B66B 11/04; B66B 9/00

(52) U.S. Cl. CPC B66B 11/0407; B66B 9/003

(57) ABSTRACT

An elevator system (20) is disclosed. The elevator system (20) includes a hoistway (22, 26, a transfer station (34, 36, 42), and a propulsion system (50). The propulsion system (50) may include a moving part (52) mounted on the elevator car (24), and a stationary part (54). An interaction of the moving part (52) and the stationary part (54) may generate a thrust force to move the elevator car (24) in a vertical direction within the hoistway (22, 26) and the transfer station (34, 36, 42). The stationary part (54) may include a first section (80) disposed in the hoistway (22, 26), and a second section (26) disposed in the transfer station (34, 36, 42), the second section (82) having thrust force generation characteristics different from thrust force generation characteristics of the first section (80).

### FIELD OF THE DISCLOSURE

The present disclosure relates generally to elevators and, more particularly, to self-propelled elevator systems.

### BACKGROUND OF THE DISCLOSURE

Self-propelled elevator systems, in some instances referred to as ropeless elevator systems, are useful in certain applications, such as, high rise buildings, where the mass of the ropes for a conventional roped elevator system is prohibitive and it is beneficial to have multiple elevator cars in a single shaft. In some self-propelled elevator systems, a first hoistway is designated for upward travel of the elevator cars, and a second hoistway is designated for downward travel of the elevator cars. In addition, transfer stations may be used to move the elevator cars horizontally between the first and second hoistways.

### SUMMARY OF THE DISCLOSURE

An exemplary embodiment of the present invention is directed to an elevator system. The exemplary elevator system may comprise a hoistway comprising a plurality of paths in which an elevator car is configured to travel, the hoistway comprising a plurality of levels. The elevator system may further comprise a transfer station operatively connected to the plurality of paths of the hoistway, and a propulsion system. The propulsion system may comprise a moving part mounted on the elevator car, and a stationary part, an interaction of the moving part and the stationary part generating a thrust force to move the elevator car in a vertical direction within the hoistway and the transfer station. The stationary part may comprise a first section disposed in the hoistway, and a second section disposed in the transfer station, the second section having thrust force generation characteristics different from thrust force generation characteristics of the first section.

According to another embodiment, a method for propelling an elevator car in an elevator system is disclosed. The method may comprise generating thrust force to propel the elevator car in a vertical direction within a hoistway of the elevator system, and generating less thrust force to propel the elevator car in a vertical direction into and out of a transfer station of the elevator system.

According to yet another embodiment, a ropeless elevator system is disclosed. The ropeless elevator system may comprise a first hoistway in which an elevator car travels upward through a plurality of levels; a second hoistway in which the elevator car travels downward through the plurality of levels; a transfer station positioned across the first hoistway and the second hoistway, the elevator car moveable from the first hoistway to the second hoistway when disposed in the transfer station; and a propulsion system disposed on the elevator car and in the first hoistway, the second hoistway, and the transfer station. The propulsion system may include a moving part mounted on the elevator car, and a stationary part, the interaction of the moving part and the stationary part generating a vertical thrust force to the elevator car within the first hoistway, the second hoistway, and the transfer station. The stationary part may comprise a first section disposed in a level of the first hoistway and the second hoistway, and a second section disposed in the transfer station, the second section including a reduced size compared to a size of the first section.

Although various features are disclosed in relation to specific exemplary embodiments, it is understood that the various features may be combined with each other, or used alone, with any of the various exemplary embodiments without departing from the scope of the disclosure. For example, less thrust force may be generated by the interaction of the moving part and the second section than by the interaction of the moving part and the first section. The interaction of the moving part and the second section may be configured to provide thrust force sufficient to move an empty elevator car into and out of the transfer station, and the interaction of the moving part and the first section may be configured to provide thrust force sufficient to move a loaded elevator car within the hoistway.

In another example, the second section of the stationary part may be of a decreased length relative to a length of the first section of the stationary part. The second section of the stationary part may be of a decreased depth relative to a depth of the first section of the stationary part. In yet another example, there may be a decreased quantity of windings disposed in the second section of the stationary part relative to a quantity of windings disposed in the first section of the stationary part. In another embodiment, the second section of the stationary part may be of a decreased thickness relative to a thickness of the first section of the stationary part.

In other refinements, the transfer station may be positioned at or below a first level of the hoistway, and the elevator system may further comprise a second transfer station at or above a top level of the hoistway and a third transfer station at an intermediate level between the first level and the top level. The second section of the stationary part may also be disposed in the second transfer station and the third transfer station. In another refinement, the elevator system may further comprise a second hoistway in which the elevator car travels to the plurality of levels, the transfer station positioned across the first hoistway and the second hoistway, and the first section of the stationary part may also be disposed in each level of the second hoistway.

These and other aspects and features will become more readily apparent upon reading the following detailed description when taken in conjunction with the accompanying drawings.

### BRIEF DESCRIPTION OF THE DRAWINGS

FIG. 1 depicts an elevator system according to an exemplary embodiment;

FIG. 2 depicts an elevator system in another exemplary embodiment;

FIG. 3 is a top down view of an elevator car in a hoistway in an exemplary embodiment;

FIG. 4 is a top down view of a moving portion of a propulsion system in an exemplary embodiment;

FIG. 5 is a top down view of a stationary portion and a moving portion of a propulsion system in an exemplary embodiment;

FIG. 6 is a perspective view of an elevator car and a propulsion system in an exemplary embodiment;

FIG. 7 is a perspective view of a structural member and a stationary portion of a propulsion system in an exemplary embodiment;

FIG. 8 is a perspective view of a first section of a stationary portion of a propulsion system in an exemplary embodiment;

FIG. 9 is a perspective view of a second section of a stationary portion of a propulsion system in an exemplary embodiment;

FIG. 10 is a perspective view of another second section of a stationary portion of a propulsion system in an exemplary embodiment; and

FIG. 11 is a flowchart illustrating a method for propelling an elevator car in an elevator system in another exemplary embodiment.

While the present disclosure is susceptible to various modifications and alternative constructions, certain illustrative embodiments thereof will be shown and described below in detail. The invention is not limited to the specific embodiments disclosed, but instead includes all modifications, alternative constructions, and equivalents thereof.

### DETAILED DESCRIPTION

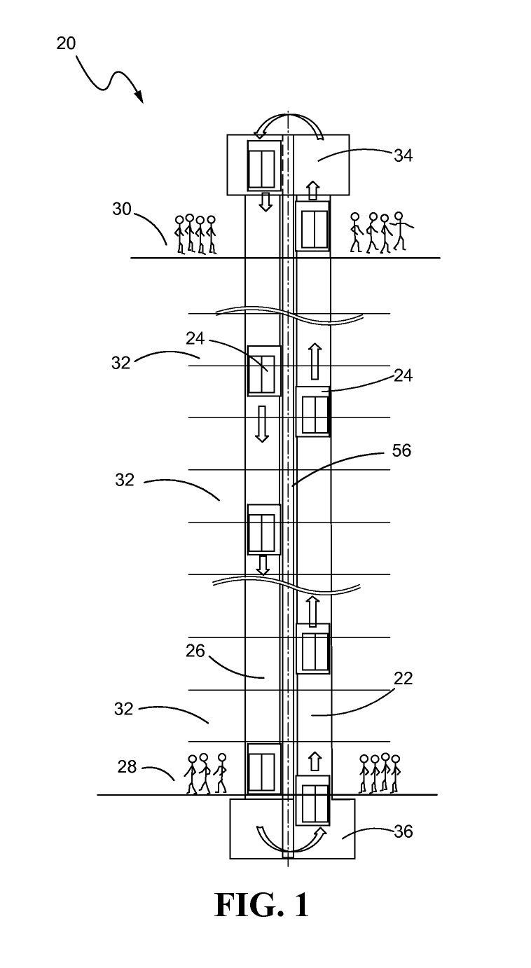

FIG. 1 depicts an elevator system 20 in an exemplary embodiment. This elevator system 20 is shown for illustrative purposes to assist in disclosing various embodiments of the invention. As is understood by a person skilled in the art, FIG. 1 does not depict all of the components of an exemplary elevator system, nor are the depicted features necessarily included in all elevator systems.

As shown in FIG. 1, the elevator system 20 includes a first hoistway 22 in which a plurality of elevator cars 24 travel upward and a second hoistway 26 in which the plurality of elevator cars 24 travel downward. Elevator system 20 transports elevator cars 24 from a first level 28 to a top level 30 in first hoistway 22, and transports elevator cars 24 from the top level 30 to the first level 28 in second hoistway 26. Although not shown, elevator cars 24 may also stop at intermediate levels 32 to allow ingress to and egress from an elevator car intermediate the first level 28 and top level 30.

Positioned across the first and second hoistways 22, 26 above the top level 30 is an upper transfer station 34. Upper transfer station 34 imparts horizontal motion to elevator cars 24 to move the elevator cars 24 from the first hoistway 22 to the second hoistway 26. It is understood that upper transfer station 34 may be located at the top level 30, rather than above the top level 30. Positioned across the first and second hoistways 22, 26 below the first level 28 is a lower transfer station 36. Lower transfer station 36 imparts horizontal motion to elevator cars 24 to move the elevator cars 24 from the second hoistway 26 to the first hoistway 22. It is to be understood that lower transfer station 36 may be located at the first level 28, rather than below the first level 28.

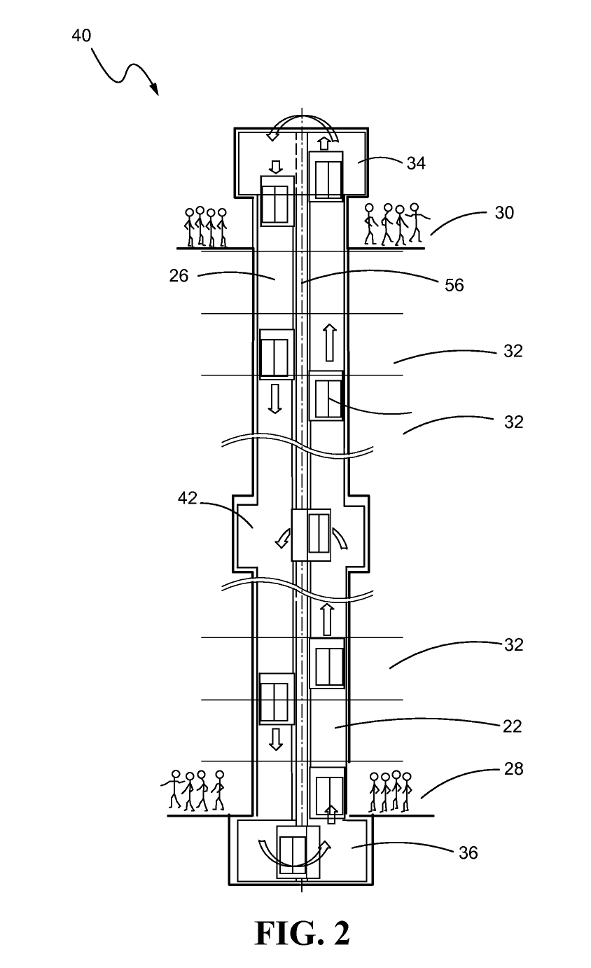

FIG. 2 depicts an elevator system 40 in another exemplary embodiment. Elements of FIG. 2 corresponding to elements in FIG. 1 are labeled with the same reference numerals where practicable. Elevator system 40 includes an intermediate transfer station 42 located between the first level 28 and the top level 30. Although a single intermediate transfer station 42 is shown, it is understood that more than one intermediate transfer station 42 may be used. Intermediate transfer station 42 imparts horizontal motion to elevator cars 24 to move the elevator cars 24 from the first hoistway 22 to the second hoistway 26 or from the second hoistway 26 to the first hoistway 22 in order to accommodate elevator car calls. Elevator cars 24 are empty when transferring from one hoistway to another at the upper transfer station 34, lower transfer station 36, and intermediate transfer station 42.

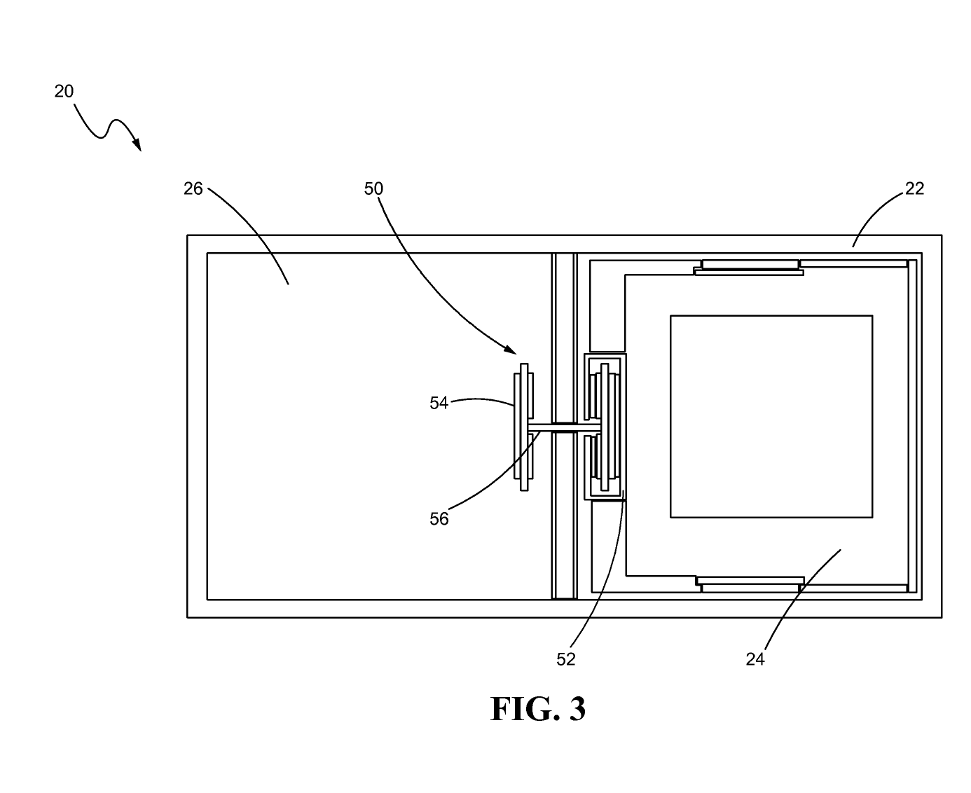

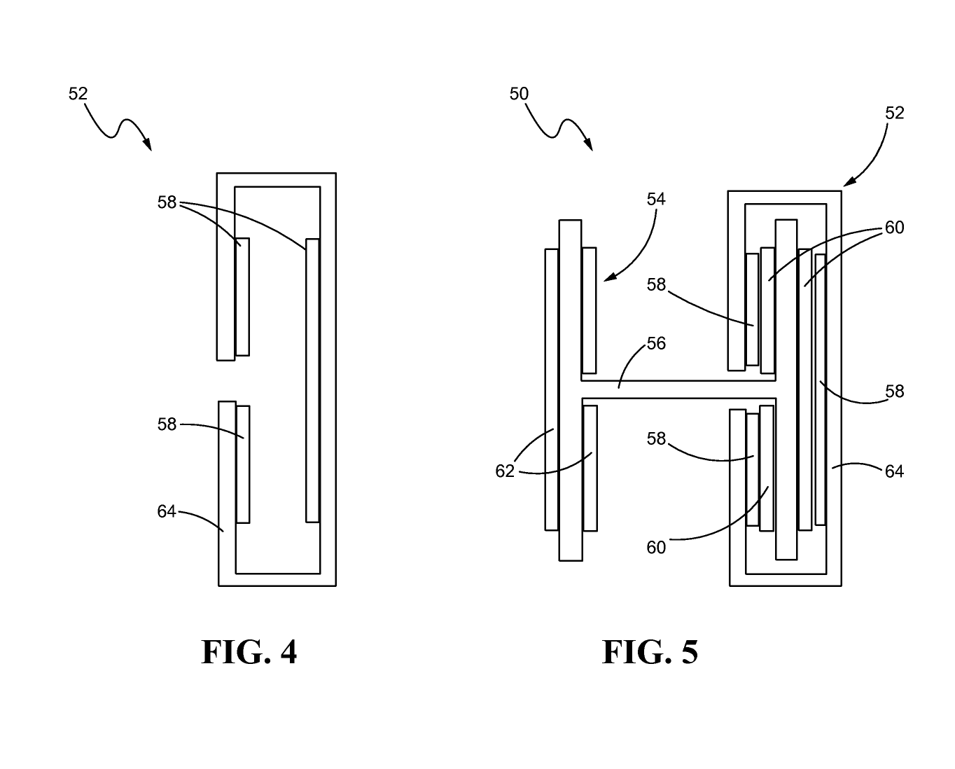

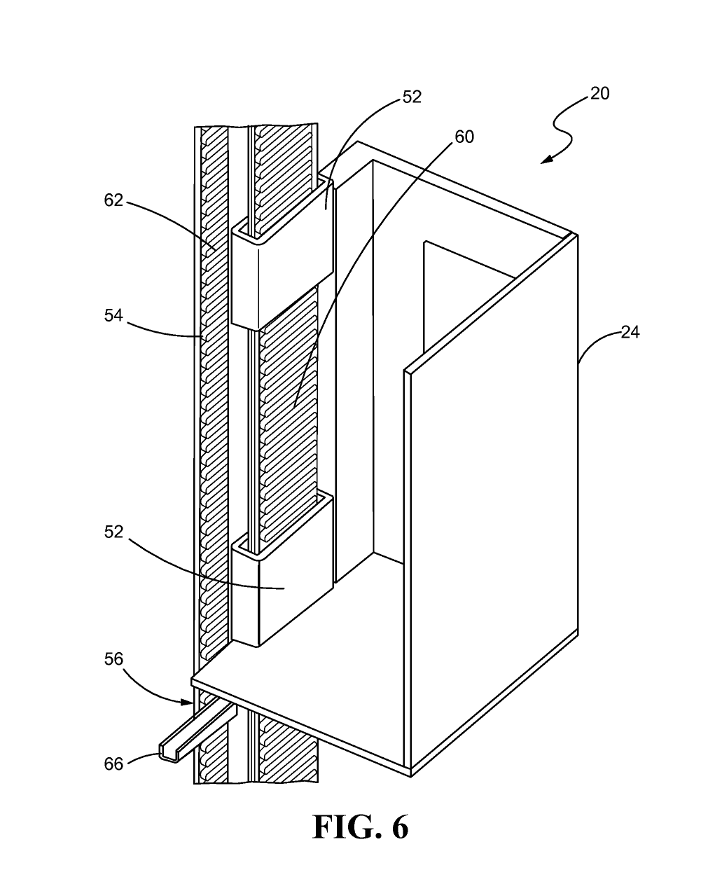

Turning now to FIGS. 3-7, with continued reference to FIGS. 1 and 2, elevator system 20 includes a propulsion system 50 disposed on the elevator cars 24, in the hoistways 22, 26, and in the transfer stations 34, 36, 42. The propulsion system 50 imparts vertical motion to elevator cars 24 to propel the elevator cars from one level to the next within the hoistways 22, 26 and into and out of the transfer stations 34, 36, 42. Different types of motors can be used for the propulsion system 50, such as, but not limited to, a linear permanent magnet motor, a flux switching motor, an induction motor, a friction motor, and the like. The propulsion system 50 may comprise a moving part 52 mounted on each elevator car 24 and a stationary part 54 mounted to a structural member 56 positioned within the hoistways 22, 26 and transfer stations 34, 36, 42. The interaction of the moving part 52 and the stationary part 54 generates a thrust force to move the elevator cars 24 in a vertical direction within the hoistways 22, 26 and transfer stations 34, 36, 42.

In an example, the moving part 52 includes permanent magnets 58, and the stationary part 54 includes windings 60, 62 mounted on structural member 56. Permanent magnets 58 may be attached to a support element 64 of the moving part 52, with the support element 64 coupled to the elevator car 24. Structural member 56 may be made of a ferromagnetic material and coupled to a wall of the first and/or second hoistways 22, 26 by support brackets 66. Windings 60, 62 may be formed about structural member 56, or may be formed about cores 68 made from a ferromagnetic material and secured to structural member 56. Windings 60 provide the stationary part of the propulsion system within the first hoistway 22, and windings 62 provide the stationary part of the propulsion system within the second hoistway 26. A support element 64 of the moving part 52 may be positioned about windings 60, 62 such that the windings 60, 62 and permanent magnets 58 are adjacent.

Windings 60 in the first hoistway 22 are energized by a power source (not shown) to propel one or more elevator cars 24 upward in the first hoistway 22 and transfer stations 34, 36, 42. When a voltage is applied to windings 60, the interaction between the windings 60 and permanent magnets 58 impart motion to the elevator car 24. Windings 62 in the second hoistway 26 operate as a regenerative brake to control descent of the elevator car 24 in the second hoistway 26 and transfer stations 34, 36, 42. Windings 62 also provide a current back to the drive unit, for example, to recharge an electrical system.

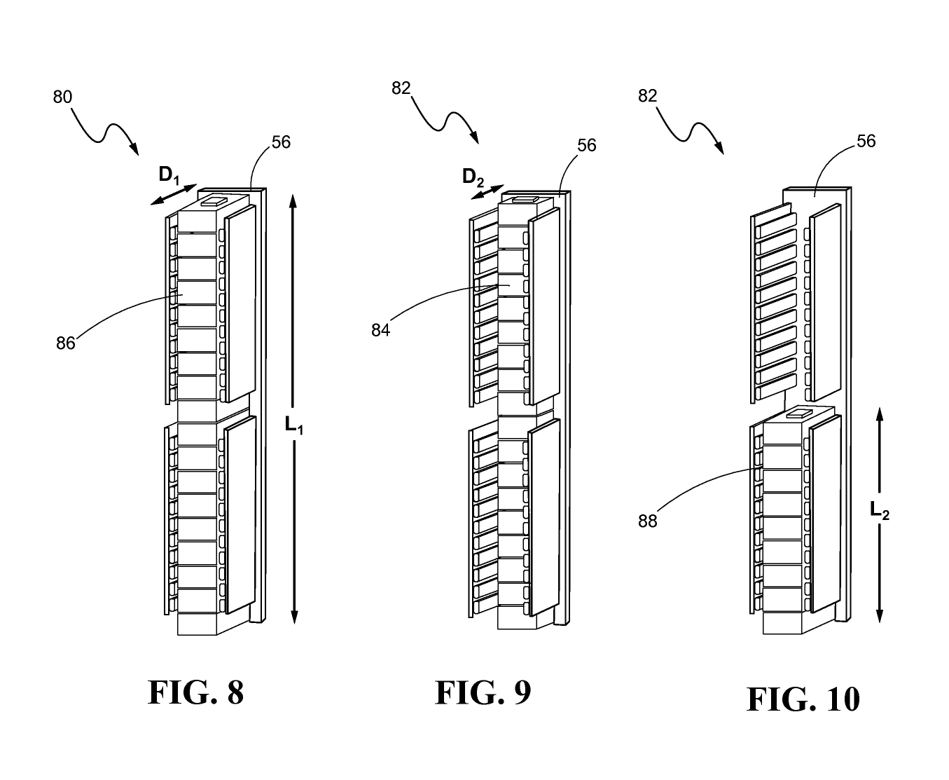

Referring now to FIGS. 8 and 9, with continued reference to FIGS. 1-7, the stationary part 54 of the propulsion system 50 may include a first section 80 disposed within the first and second hoistways 22, 26 and a second section 82 disposed within the upper, lower and intermediate transfer stations 34, 36, 42. More specifically, FIG. 8 depicts the first section 80, which may comprise the stationary part 54 in one of the levels 28, 30, 32 in one of the hoistways 22, 26; and FIG. 9 depicts the second section 82, which may comprise the stationary part 54 in one of the transfer stations 34, 36, 42. Since the elevator cars 24 are empty when transferring from one hoistway to another within the transfer stations 34, 36, 42, the propulsion system 50 located within the transfer stations needs to support only the weight of the elevator car 24 but not the weight of passengers or other loads. Within the hoistways 22, 26, the propulsion system 50 supports the weight of the elevator car 24 along with the weight of passengers or other loads.

Due to the decreased weight requirements, the stationary part 54 of the propulsion system 50 within the transfer stations 34, 36, 42 (i.e., the second section 82) may be different than the stationary part 54 of the propulsion system 50 within each level of the hoistways 22, 26 (i.e., the first section 80). For example, the second section 82 may have a reduced size compared to the first section 80. As shown in FIGS. 8 and 9, windings 84 in the second section 82 are of a decreased depth D₂ relative to a depth D₁ of windings 86 in the first section 80. Less thrust force is generated by the interaction of the moving part 52 and the second section 82 than by the interaction of the moving part 52 and the first section 80.

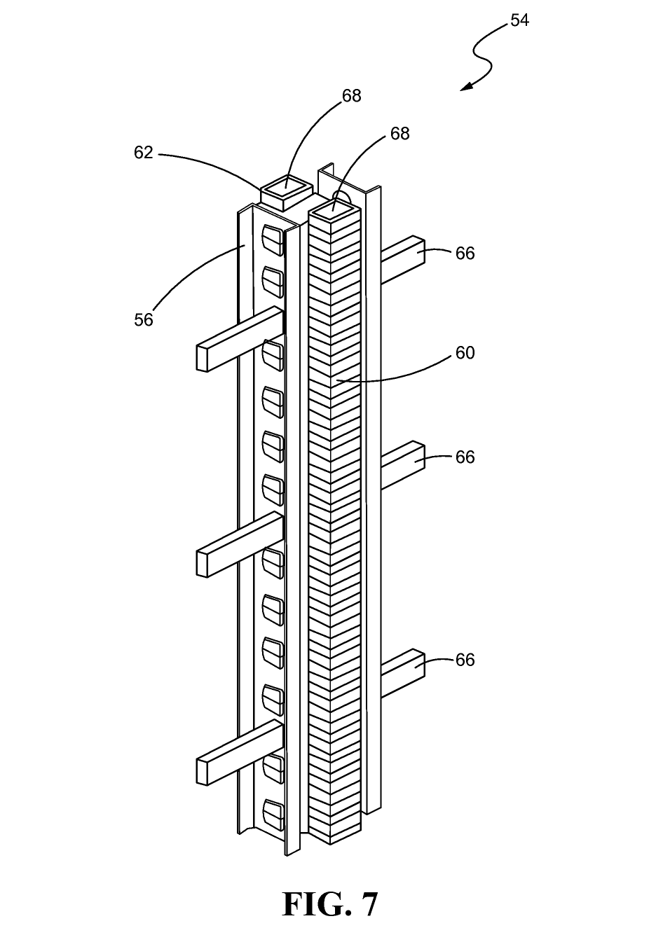

Other configurations for the second section 82 may be used to reduce the thrust force generated by the propulsion system. For example, as shown in FIG. 10, the windings 88 in second section 82 are of a decreased length L₂ relative to a length L₁ (FIG. 8) of windings 86 in the first section 80. Alternatively, there may be a decreased quantity of windings disposed in the second section relative to a quantity of windings disposed in the first section. In another exemplary embodiment, the windings in the second section may be of a decreased thickness relative to a thickness of the windings in the first section. It is to be understood that other ways to reduce the size of the windings, or a combination thereof, in the second section 82 may be used. In addition, other changes in electromagnetic parameters of the windings in the second section 82, relative to the electromagnetic parameters of the windings in the first section, 80 may be utilized to change the thrust force generated by the propulsion system in the second section 82. For example, magnetic properties of the cores 68 (FIG. 7) may be changed in the second section 82 of the stationary part 54.

Although the windings are shown located on structural member 56 and permanent magnets are mounted to the elevator car 24, it is understood that the locations of these elements may be reversed. In such embodiments, permanent magnets are stationary and extend along the structural member 56, and windings are mounted to the elevator cars 24. Furthermore, the size of the permanent magnets in the second section may be different than the size of the permanent magnets in the first section.

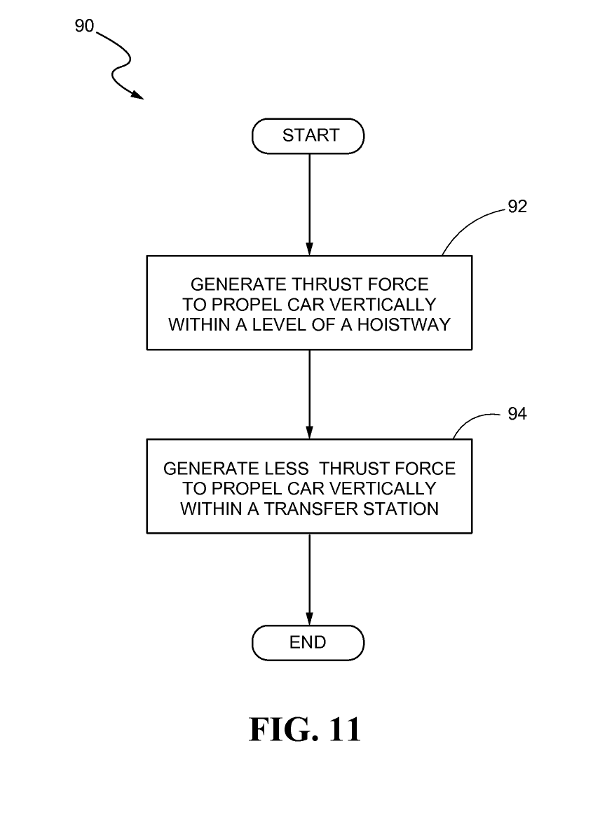

The flowchart of FIG. 11 illustrates an exemplary process 90 for propelling an elevator car 24 in an elevator system 20 according to an exemplary embodiment of the invention. At block 92, thrust force is generated to propel the elevator car 24 in a vertical direction within a level 28, 30, 32 of a hoistway 22, 26 of the elevator system 20. Next, at block 94, less thrust force is generated to propel the elevator car 24 in a vertical direction into and out of a transfer station 34, 36, 42 of the elevator system 20.

By using the elevator system and method disclosed herein, a size of the propulsion system within the transfer stations is reduced. More specifically, the size of the stationary part (e.g., the windings) in the transfer stations may be reduced. As a result, savings in a cost of the propulsion system for an elevator system can be achieved.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

While some features are described in conjunction with certain specific embodiments of the invention, these features are not limited to use with only the embodiment with which they are described, but instead may be used together with or separate from, other features disclosed in conjunction with alternate embodiments of the invention.

What is claimed is:

1. An elevator system (20) comprising:
a hoistway (22, 26) comprising a plurality of paths in which an elevator car (24) is configured to travel, the hoistway (22, 26) comprising a plurality of levels (28, 30, 32);
a transfer station (34, 36, 42) operatively connected to the plurality of paths of the hoistway (22, 26); and
a propulsion system (50) comprising:
a moving part (52) mounted on the elevator car (24), and
a stationary part (54), an interaction of the moving part (52) and the stationary part (54) generating a thrust force to move the elevator car (24) in a vertical direction within the hoistway (22, 26) and the transfer station (34, 36, 42), the stationary part (54) comprising:
a first section (80) disposed in the hoistway (22, 26), and
a second section (82) disposed in the transfer station (34, 36, 42), the second section (82) having thrust force generation characteristics different from thrust force generation characteristics of the first section (80).

2. The elevator system of claim 1, wherein less thrust force is generated by the interaction of the moving part (52) and the second section (82) than by the interaction of the moving part (52) and the first section (80).

3. The elevator system of claim 1, wherein the interaction of the moving part (52) and the second section (82) is configured to provide thrust force sufficient to move an empty elevator car (24) into and out of the transfer station (34, 36, 42), and wherein the interaction of the moving part (52) and the first section (80) is configured to provide thrust force sufficient to move a loaded elevator car (24) within the hoistway (22, 26).

4. The elevator system of claim 1, wherein the second section (82) of the stationary part (54) includes a decreased length (L₂) relative to a length (L₁) of the first section (80) of the stationary part (54).

5. The elevator system of claim 1, wherein the second section (82) of the stationary part (54) includes a decreased depth (D₂) relative to a depth (D₁) of the first section (80) of the stationary part (54).

6. The elevator system of claim 1, wherein the second section (82) includes a decreased quantity of windings relative to a quantity of windings in the first section (80).

7. The elevator system of claim 1, wherein the second section (82) includes a decreased thickness relative to a thickness of the first section (80).

8. The elevator system of claim 1, wherein the transfer station (36) is positioned at or below a first level (28) of the hoistway (22, 26), and wherein the elevator system (20) further comprises a second transfer station (34) at or above a top level (30) of the hoistway (22, 26) and a third transfer station (42) at an intermediate level between the first level (28) and the top level (30), the second section (82) of the stationary part (54) also disposed in the second transfer station (34) and the third transfer station (42).

9. The elevator system of claim 1, further comprising a second hoistway (26) in which the elevator car (24) travels to the plurality of levels (28, 30, 32), the transfer station (34, 36, 42) positioned across the hoistway (22) and the second hoistway (26), the first section (80) of the stationary part (54) also disposed in each level (28, 30, 32) of the second hoistway (26).

10. A method (90) for propelling an elevator car (24) in an elevator system (20), comprising:
generating thrust force to propel the elevator car (24) in a vertical direction within a hoistway (22, 26) of the elevator system (20); and
generating less thrust force to propel the elevator car (24) in a vertical direction into and out of a transfer station (34, 36, 42) of the elevator system (20).

11. The method of claim 10, wherein generating less thrust force includes using a shorter stationary part (54) of a propulsion system (50) in the transfer station (34, 36, 42) compared to the stationary part (54) of the propulsion system (50) in the hoistway (22, 26).

12. The method of claim 10, wherein generating less thrust force includes using a shorter length (L₂) of windings (88) in a stationary part (54) of a propulsion system (50) in the transfer station (34, 36, 42) compared to a length (L₁) of windings (86) in the stationary part (54) of the propulsion system (50) in the hoistway (22, 26).

13. The method of claim 10, wherein generating less thrust force includes using a shorter depth (D₂) of windings (84) in a stationary part (54) of a propulsion system (50) in the transfer station (34, 36, 42) compared to a depth (D₁) of windings (86) in the stationary part (54) of the propulsion system (50) in the hoistway (22, 26).

14. The method of claim 10, wherein generating thrust force to propel the elevator car (24) in the vertical direction within the hoistway (22, 26) includes supporting weight of the elevator car (24), passengers, and loads in the elevator car (24).

15. The method of claim 14, wherein generating less thrust force to propel the elevator car (24) in the vertical direction into and out of the transfer station (34, 36, 42) includes supporting weight of the elevator car (24) only.

16. A ropeless elevator system (20) comprising:
a first hoistway (22) in which an elevator car (24) travels upward through a plurality of levels (28, 30, 32);
a second hoistway (26) in which the elevator car (24) travels downward through the plurality of levels (28, 30, 32);
a transfer station (34, 36, 42) positioned across the first hoistway (22) and the second hoistway (26), the elevator car (24) moveable from the first hoistway (22) to the second hoistway (26) when disposed in the transfer station (34, 36, 42); and
a propulsion system (50) disposed on the elevator car (24) and in the first hoistway (22), the second hoistway (26), and the transfer station (34, 36, 42), the propulsion system (50) including:
a moving part (52) mounted on the elevator car (24), and
a stationary part (54), the interaction of the moving part (52) and the stationary part (54) generating a vertical thrust force to the elevator car (24) within the first hoistway (22), the second hoistway (26), and the transfer station (34, 36, 42), the stationary part (54) comprising:
a first section (80) disposed in a level (28, 30, 32) of the first hoistway (22) and the second hoistway (26), and
a second section (82) disposed in the transfer station (34, 36, 42), the second section (82) including a reduced size compared to a size of the first section (80).

17. The ropeless elevator system of claim 16, wherein the second section (82) includes a change in electromagnetic parameters relative to electromagnetic parameters of the first section (80).

18. The ropeless elevator system of claim 16, wherein the second section (82) includes a reduced depth (D₂) compared to a depth (D₁) of the first section (80).

19. The ropeless elevator system of claim 16, wherein the second section (82) includes a reduced length (L₂) compared to a length (L₁) of the first section (80).

20. The ropeless elevator system of claim 16, wherein less thrust force is generated by the interaction of the moving part (52) and the second section (82) than by the interaction of the moving part (52) and the first section (80).
